(19) United States
(12) Patent Application Publication
(10) Pub. No.: US 2019/0139378 A1
(43) Pub. Date: May 9, 2019

(54) COMMUNICATION OR SIGNALING SYSTEM THAT INCLUDES A VARIABLE PRESSURE ACTIVATED POROUS VOLUME EMITTER ALONG WITH RELATED METHODS

(71) Applicant: United States Government, as represented by the Secretary of the Navy, Crane, IN (US)

(72) Inventors: Jules E. Pienkos, Bloomington, IN (US); Aaron B. Cole, Bloomington, IN (US)

(21) Appl. No.: 16/184,976

(22) Filed: Nov. 8, 2018

Related U.S. Application Data
(60) Provisional application No. 62/583,450, filed on Nov. 8, 2017.

(51) Int. Cl. G08B 6/00; F15D 1/14; F15D 1/02

(52) U.S. Cl. CPC G08B 6/00; F15D 1/02; F15D 1/14

(57) ABSTRACT

An exemplary communication or signaling system that includes an energy emission system that can include a control system, a fluid reservoir, fluid transfer structures, a fluid pumping system, an emission structure, an enclosure extending away from the fluid emission structure, a fluid recovery system, and a lens structure adapted to pass energy through the lens structure. The emission structure can include a porous structure and/or structure(s) with a number of fluid emission sections that generate one or more fluid structures such as droplets or other fluid shapes which increase or decrease fluid surface area on the fluid emission structure and thereby increase or decrease energy emissions or absorption on or in relation to the fluid emission structure. The control system can selectively modulate pressure/fluid transfer via the pump into the fluid transfer structures which alter energy emission or absorption that can be detected at a distance.

### CROSS-REFERENCE TO RELATED APPLICATION

This application claims priority to U.S. Provisional Patent Application Ser. No. 62/583,450, filed on Nov. 8, 2017, entitled “VARIABLE PRESSURE ACTIVATED POROUS VOLUME EMITTER”, the disclosure of which is expressly incorporated herein by reference.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 200,508 and 200,007) is assigned to the United States Government and is available for licensing for commercial purposes. Licensing and technical inquiries may be directed to the Technology Transfer Office, Naval Surface Warfare Center Crane, email: Cran_CTO@navy.mil.

### FIELD OF THE INVENTION

The field of the invention relates generally to communication or signaling systems that can include devices that leverage various principles including how thermal or electro-magnetic energy radiation is a function of surface area. In particular, exemplary embodiments are provided that includes various functions including systems or processes to manipulate surface area to increase or decrease an amount of thermal energy transfer which can be sensed remotely.

### BACKGROUND AND SUMMARY OF THE INVENTION

Various embodiments of the current invention may be applicable to several commercial applications where infrared fluence is of benefit such as the following: aircraft avoidance, personnel search and rescue in maritime, arboreal, and mountainous regions, and automobile collision avoidance. Various embodiments of the invention can include designs which enable substantial reduction of power use, e.g., in thermal applications, as well as providing a capacity to modulate emission or absorption in a variety of ways which provide significant advantages over the prior art.

Existing technology utilizes activated solid structures or excited fluids to alter the state of the source to achieve imaging, illumination or absorption. Additionally, plasmas can also be used as a source but are energy inefficient for this application.

Embodiments of this disclosure improve over existing solutions or technology by utilizing a modulated or controlled pressure driven flow of a fluid to alter surface area conditions to create a system for creating a communication or signaling system. Different embodiments of this disclosure may allow for other advantages over current technology such as enhancing sensing abilities over a greater range than typical visualization allows, developing low cost sensing equipment, creating a smaller form factor over conventional technology, permitting a high emissivity versus device two dimensional projection of three-dimensions (3D) volume, allowing for flexible design capabilities (i.e., sweeping specific spectral ranges), and creating a manual emissivity by user in case of power failure power were to fail, and the capability for modular/plug and play.

Methods as well as exemplary energy emission systems are provided that can include a control system, a fluid reservoir, fluid transfer structures, a fluid pumping system, a fluid emission structure, an enclosure extending away from the fluid emission structure, a fluid recovery system, and a lens structure adapted to pass energy through the lens structure. The exemplary fluid emission structure can include a porous structure and/or structure(s) with a number of fluid emission sections that generate one or more fluid structures such as droplets or other fluid shapes which increase or decrease fluid surface area on the fluid emission structure and thereby increase or decrease energy emissions or absorption on or in relation to the fluid emission structure. The exemplary control system can include modulation control instructions or control sections which selectively modulate pressure generated by the fluid pumping system into the fluid transfer structures. Exemplary fluid transfer structures pass fluid to the fluid emission structure.

### BRIEF DESCRIPTION OF THE DRAWINGS

The detailed description of the drawings particularly refers to the accompanying figures in which:

FIG. 1 shows a simplified system architecture for one embodiment of the invention;

FIG. 2 shows an exemplary side view of one embodiment of an exemplary variable pressure activated porous volume emitter;

FIG. 3 shows an alternate exemplary side view of one embodiment of an exemplary variable pressure activated porous volume emitter;

FIG. 4 shows another exemplary embodiment of an exemplary variable pressure activated porous emitter that has a valves (or optionally separate pumps) that are operated to generate spatially independent flows through different flow paths allowing for localized fluid interaction or different patterns on a given emissive surface;

FIG. 5 shows three exemplary pressure curves of an exemplary fluid generated within or from an exemplary emittance space of an exemplary embodiment showing an exemplary modulation of pressure associated with a desired communication or signaling modulation;

FIG. 6 shows three exemplary pressure curves of pressure modulation of exemplary fluid(s) in an exemplary emittance space in relation to an exemplary porous volume emitter wherein these exemplary altered fluid states in an exemplary emittance space may enable or provide for controllable view factors; and

FIGS. 7A and 7B shows a method of operation of a system in accordance with one embodiment of the invention.

### DETAILED DESCRIPTION OF EMBODIMENTS OF THE INVENTION

Embodiments of the disclosure described herein are not intended to be exhaustive or to limit the disclosure to precise forms disclosed. Rather, the embodiments selected for description have been chosen to enable one skilled in the art to practice the disclosure.

Generally, one or more embodiments of the invention may be provided in a beacon or energy, e.g., thermal, emission source. An exemplary device may modify or adjust an apparent rate of energy exchange or emission by adjusting or altering surface area of a fluid with a given temperature via the use of droplet sprays or emission of the fluid from a surface or nozzle(s), etc which is a part of the beacon or energy emission source. In at least some embodiments, porous media or nozzle structures within the exemplary apparatus may be used in combination with a variety of pressure drop methods to alter flows through a droplet creation device which changes surface area of the fluid when it expands/erupts from a surface of a structure into an emittance space within the beacon or energy emission source (e.g., a space between a surface or media that exudes droplets or fluid and a lens structure).

Exemplary droplet sprays can include fluid flows that begin as a jet or slug of liquid and are expanded or erupted into a relatively smaller localized mass flow in which the density is greatly decreased. A porous media structure may any structure through which either deterministic or non-deterministic fluid flow occurs from one region of a structure at high pressure and which erupts into droplets from a different region experiencing lower pressure. A deterministic flow can include a flow path of known entry and exit points predetermined by the geometry. Deterministic flow paths examples can be analogous to simple tubes/pipes. An exemplary non-deterministic flow ca be brought about by chaotically transferring a fluid through a variety of or any combination of paths between entry and exit points. Nozzle based structures can be based upon a device having a variable cross-sectional area through which a fluid undergoes a pressure drop to create droplets or droplet spray.

Exemplary pressure drop methods can utilize high pressures at entrance points and expand into an unbound region at the exit point. Exemplary droplet creation devices may be further expanded to refer to any, all of, or a combination of the porous media, nozzle, and alternate methods. A perceived or exemplary surface area of the exemplary fluid can include an observable volumetric space occupied by droplets in an exemplary emittance space upon expansion from a surface of an exemplary droplet creation device.

Exemplary expansion, as described in relation to at least one embodiment, can refer to a decrease in fluid density by a device that has increasing cross sectional area through the flow path into the emittance space. Eruption can be defined as an ejection of droplets from a fine structure, such as a porous media, mesh, screen, etc. in which the flow is pressurized at the plenum or inlet(s) of the media, mesh, screen, etc, and a lower pressure volume at the exit or the emittance space. An emittance space defined by a space between a lens and an emissive surface from an exemplary porous media can be maintained at a lower relative pressure volume where inlet and outlet liquid mass is controlled such that droplets or droplet spray(s) are periodically modulated to expand or erupt into a volume where apparent emissivity is optimized.

An exemplary surface area can be significant to an emissive surface. An exemplary perceived surface area can be created by the formation and removal of the localized fluid droplets creates an emittance. By designing a controllable, continuously altering perceived surface area state, an exemplary device provides a variety of novel functions or capabilities.

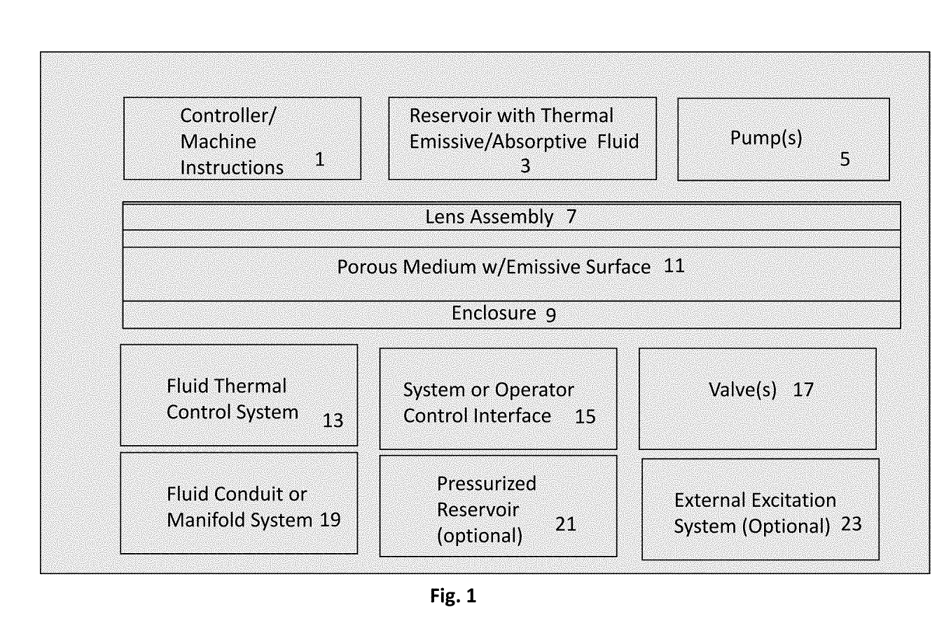

Referring to FIG. 1, a simplified system architecture for one embodiment of the invention. In particular, an embodiment can include a controller/machine instruction system 1 which can control various elements of this embodiment including one or more pumps 5, a fluid thermal control system 13, valves, 17, an optional external excitation system 23 which receives inputs from, e.g., a system operator or control interface 15. An exemplary enclosure, housing, or support structure 9 is provided which has an emissive structure such as a porous medium with an emissive surface 11 positioned in relation to a lens assembly 7 where an emissive space gap is provided for between the lens assembly 7 and the porous medium 11. Valve(s) 17, fluid conduit or manifold system 19, reservoir with thermal emissive/absorptive fluid 3 are fluidly coupled with the porous medium 11 where the controller operates the pump(s) 5 and valves 17 to pass fluid from the reservoir 3 into the porous medium based on a modulation or signaling control sequence from the controller/machine instruction 1 to exude or retract fluid from the porous medium's emissive surface 11 to adjust effective surface area of the emissive surface and thereby change the surface's energy profile (e.g., thermal emissions or absorptive profile). Using this changing surface energy absorptive or emissive effect, an operator can use the system to produce a detectable energy, e.g., thermal or infrared, profile or signal sequence that can be used to communicate with an external party equipped to detect this profile or sequence.

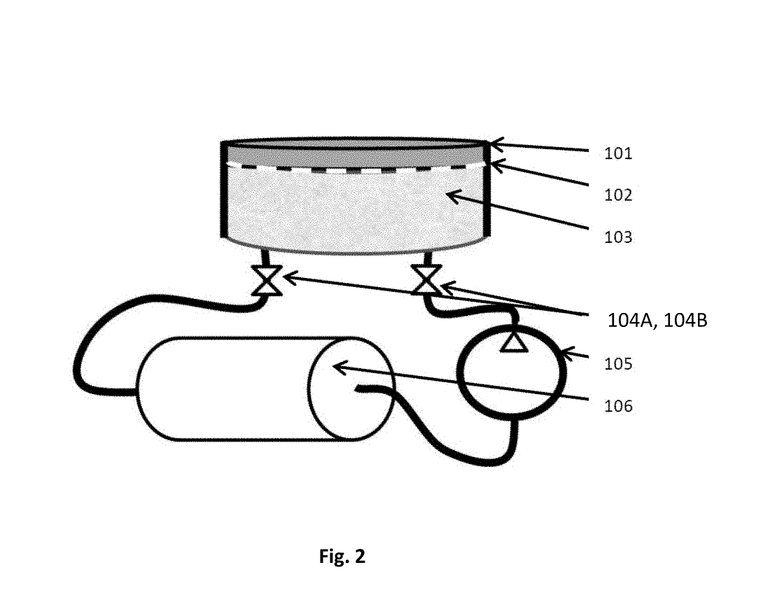

Referring to FIG. 2, a general embodiment an exemplary porous volume emitter may include a transmissive window or surface top 101 that serves as a physical cover of the emitter. Some embodiments can include a variety of surface area design features, variable and static topography, other typical and atypical geometrical enhancements, as well as a potential mount for polarization and or filtering optics. An emissive surface 102 is provided that may be a structure from with fluid is introduced to emit infrared radiation. The exemplary emissive surface 102 may include a plurality of apertures in liquid communication with a porous media 103. The plurality of apertures may vary in shape and size in order to increase or decrease surface area of droplets emitted from the emissive surface 102. In at least some embodiments fluid in the porous volume emitter may exude and retract out of emissive surface 102 due to changing pressure applied to the porous volume emitter. The fluid exuded from the plurality of apertures or pores in the emissive surface 102 may form beads, semi-spherical shapes, droplets, etc on the emissive surface 102 by limiting pressure acting on the fluid in the porous media so cohesive forces created by the surface tension of the fluid is greater than the external forces acting on the fluid. Thus, a plurality of beads of fluid or fluid defined by a semi-spherical surface area may be positioned on the emissive surface 102 and retracted by applying pressure on the fluid and then removing the pressure and even applying suction on a porous structure with the emissive surface 102.

Some embodiments may have a hydrophobic substance, e.g., wax, applied to surface areas surrounding pores in the emissive surface 102 which then adds to the emissive surface 102 ability to form beads or droplets and retain them in place without having the beads or droplets flow away from the pores in the emissive surface 102.

In some embodiments, the emissive surface 102 may include a drainage or fluid recovery system. The drainage or fluid recovery system may include at least one aperture (not shown) configured to collect fluid generated from the emissive surface 102. The drainage or recovery system may divert the fluid to prevent pooling of emitted liquid on the emissive surface 102. The porous media 103 may direct the fluid within the device by altering the pressure through a variety of pressure drop methods, which may include but are not limited to, nozzles, frictional forces, valves, diffuser or the like. Porous media 103 may include predetermined flow paths for the liquid such that structure enhancing thermal exchange, fluid mixing, droplet size, surface wettability, and fundamental emissivity may be easily manipulated.

Inlet and outlet valves 104A, 104B may regulate the flow of fluid into and out of the porous media 103. The valves 104A, 104B may be configured to accurately or selectively manipulate flow of fluid through the emitter by selectively increasing or decreasing fluid pressure which in turn causes fluid to exude from pores in the emissive surface 102. In an exemplary embodiment, an outlet valve 104B may be in fluid communication with the drainage or recovery system so that excess fluid may be returned from the emissive surface 102. One possible design approach of forcing fluid flow through the porous media 103 can include use of pressurization at an inlet valve 104A and relieving pressure at the outlet valve 104B. This pressurization may alter fluid flow throughout the emitter or a part of the emitter. Pressurization can also be controlled or altered to create variable, unnatural excited states in the fluid that are at the same time controllable. The exemplary fluid flow field can culminate at a surface top 101 creating an emissive source modulation event. Exemplary fluid mass flow may also be controlled to generate localized unsteady flow field that results in a varied fluid surface area in the droplets. This variable fluid surface at the emissive surface can create altered states that allow for imaging, illumination, and/or absorption that allows for relative ease in state changes and provides an efficient emissive source.

In some embodiments, valves (e.g., 104A, 104B) may be controlled by a controller operated by a user. The controller may configure the position of the values so as to generate a desired pressure in the porous volume emitter. Valves 104, 104 may also determine or produce pressure gradients, and adjust flow and amount of fluid in the porous media 103 with or without additional pressure modulation from pump.

A fluid modulation device 105 may be designed or configured to selectively move fluid through the porous volume emitter in at least some embodiments. The fluid modulation device 105 may be a pump, a compressor or any suitable device configured to modulate pressure in a fluid system that includes a porous media. In some embodiments a fluid reservoir 106 may store, collect, transfer, thermally regulate, and/or filter the fluid in the porous volume emitter. In one exemplary embodiment, the fluid modulation device 105 may also include a vibration and a pressure inducing mechanism. Fluid reservoir 106 may be connected to inlet and outlet valves 104A, 104B in some embodiments. In some embodiments, fluid modulation device 105 may act in communication with input valve 104A and output valve 104B to oscillate pressure in the exemplary porous volume emitter system. The fluid modulation device 105 may oscillate pressure from a higher pressure to a lower pressure or may reverse the direction of fluid via positive or negative pressure, pushing fluid through the porous media 103 and then sucking it back toward the fluid modulation device 105.

The exemplary fluid modulation device 105 may regulate the pressure of the fluid in the porous volume emitter to keep the fluid on the emissive surface 102. In some embodiments, the fluid modulation device 105 may be held at a steady pressure or reverse the direction of the pressure after enough fluid has traveled through the porous volume emitter so that the fluid may form beads on the emissive surface 102, rather than flow out of the emissive surface 102. In other embodiments, the fluid modulation device 105 may increase pressure in the porous volume emitter so that the fluid spews or selectively sprays out of the emissive surface 102 to generate different surface area or spray patterns.

In some embodiments, a porous volume emitter may be used as an apparent thermal source. Such a source could generate or produce different states to allow for imaging, illumination, and/or absorption. These exemplary different states can be achieved by altering a fundamental aspect to the basic physics of the energy relationship, such as changing the pressure, or, on a given emissive surface area. The exemplary porous volume emitter may alter surface area of exemplary fluid(s), and thus energy radiation, by pressure changes as the fluid is force through the porous media 103 and formed into droplets or fluid flows or bodies which emit from emissive surface 102. The exemplary fluid temperature may not significantly change within the porous media 103 but, in some embodiments, may appear to have different temperature states when changing the emissivity to increased or decreased fluid surface area. An exemplary porous volume emitter may greatly improve the quality and speed at which the source can allow for visualization by increasing differences in fluid surface area states or speed at which the different states can be achieved through manipulation of fluid or emissive surface area by forcing the fluid through predetermined paths of the porous media 103. Exemplary alternative embodiments may have a plurality of selectively and independently controlled fluid paths or conduits (not shown) to the emissive surface which can generate individually controlled fluid emissions which each produce different emission patterns.

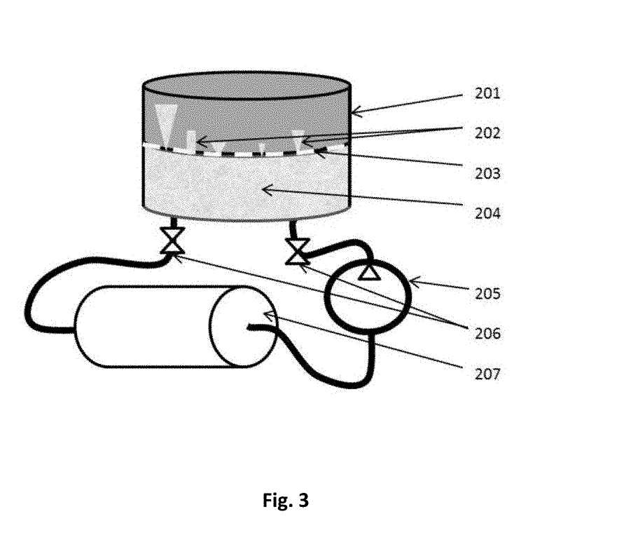

Referring to FIG. 3, an alternate embodiment of a FIG. 2 exemplary embodiment is shown which may include structures or ports 203 that emit or generate emissive plumes 202 from the port(s) 203. The emissive plumes 202 can be produced from emissive plume ports 203 that may comprise various geometric shapes designed to produce a predetermined surface area in the fluid droplets formed into different shapes including the plumes 202. Emissive plumes 202 may also comprise various spray densities to modify the apparent emissivity of the exemplary fluid.

Various alternative embodiments of the invention may also include an external excitation instrument (not shown) which may include, but, is not limited to, a microwave, a radio frequency emitter, or optical wave machine or the like which is oriented towards droplets or fluid. External excitation instrument may cause agitation of the particles in the fluid in various flow fields. An alternate embodiment of the porous volume emitter may also include a pressurized tank 109 connected to the porous media 103 so that fluid may be distributed evenly upon entering the fluid paths or conduits of the porous media 103. The exemplary pump 105 may move fluid into the pressurized tank 109 until it reaches a predetermined pressure where the fluid will then move through the porous media 103 to the emissive surface 102.

An alternative embodiment can add a recovery reservoir (not shown) with an additional valve(s) coupling the recovery reservoir with various portions of a given embodiment the which selectively can recover fluid from different sections of an embodiment. For example, an embodiment can include a fluid conduit that couple a separate recovery reservoir with an emissive space between a lens and a surface of the porous media facing the lens. An embodiment can include a variant which returns recovered fluid to pressurized tank 109 via connection to a pump or back to an unpressurized reservoir which is coupled with pump

In some embodiments, a plurality of input valves 104 may be used to control the amount of fluid delivered to the porous media 103 or pressurized tank 109 from the pump 105. The plurality of input valves 104 can provide selective fluid communication between the pump 105, the fluid reservoir 106, the pressurized tank 109, and/or the porous media 103.

Alternative embodiments can include designs where pump and reservoir structures are provided in alternative configurations. For example, a pump may be disposed between or adjacent porous media 103 and reservoir 106 such that the pump can move fluid into or out of the porous media 103. In this embodiment, the pump draws fluid from the reservoir 106 and pumps 105 it into the porous media 103 when moving fluid into the porous media 103 in order to exude or extend fluid from the porous media's 103 pores and thereby increase surface area on the porous media's 103 surface and thereby alter infrared emissive or absorptive profiles of an emissive surface 102 of the porous media 103 with respect to an observer.

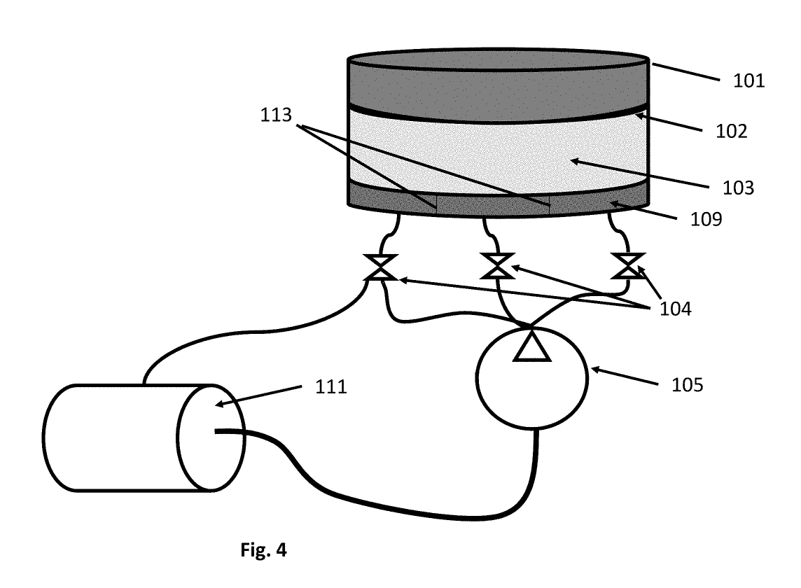

Referring to FIG. 4, another exemplary embodiment of an exemplary variable pressure activated porous emitter is shown that has multiple valves (or optionally separate pumps) that are operated to generate spatially independent flows through different flow paths allowing for localized fluid interaction or different patterns on a given emissive surface. In at least some embodiments, a separation or compartmentation of an alternative embodiment can include one based on a variant of FIG. 2 that can add an additional reservoir 111 which is coupled with the pressurized tank 109 and pump (and reservoir) 105 via added valve(s) 104 where the additional reservoir 111 is also coupled with the pump (and reservoir 105. Optionally, partitioned areas formed by divider structures 113 can be formed or included in pressurized tank 109 which enables or facilitates the spatially independent flows through the porous media 103 and further enable selective patterns on the porous media 103 surface. Separate fluid inputs or conduits coupled to each valve 104 can be provided to each partitioned area. The porous media 103 can further be modified to have barriers or dividers (not shown) which further partition flow paths through the porous media 103.

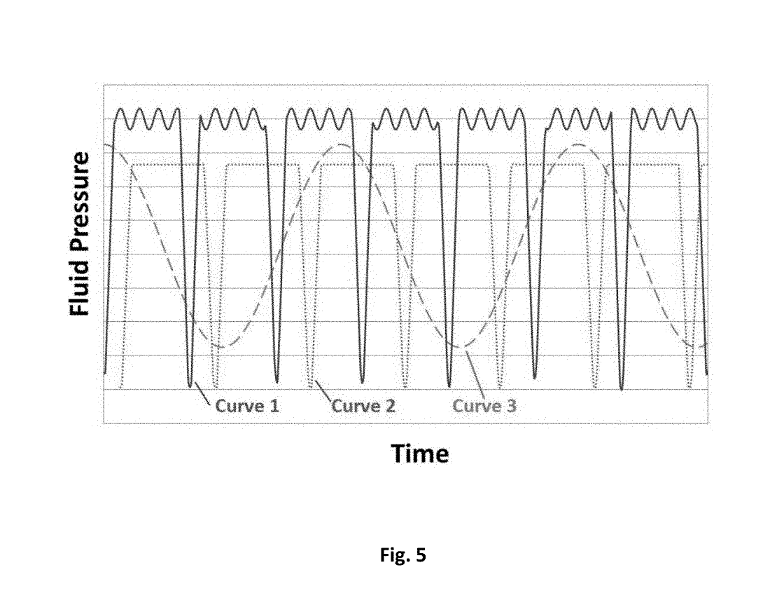

Referring to FIG. 5, three exemplary pressure curves are shown of pressure modulation of exemplary fluid(s) in an exemplary emittance space in relation to an exemplary porous volume emitter are shown. These exemplary altered fluid states in the exemplary emittance space may enable or provide for controllable view factors. The exemplary pressure curves can have a large variety of possible profiles that can depend or be based on a variety of design tradeoffs such as expansion method, fluid material, maximum pressure, and/or porous media 103. These exemplary curves provide examples that are associated with possible pressure changes and therefore not definitive or limiting to design space tradeoffs or choices.

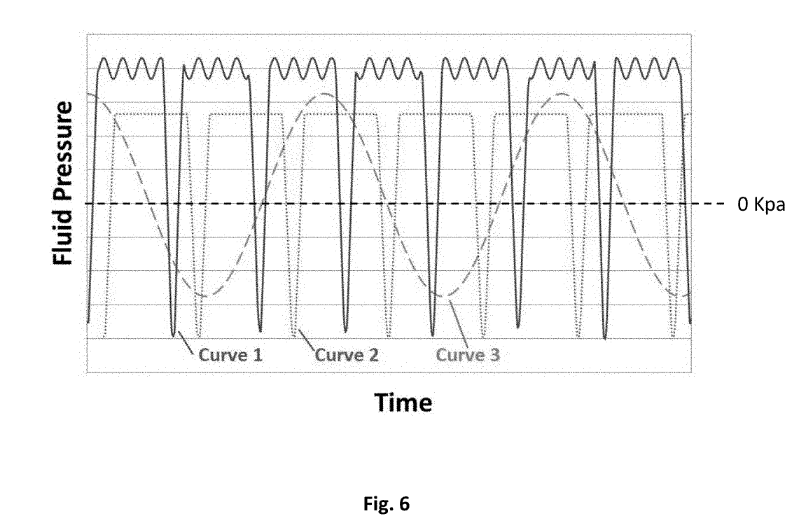

FIG. 6 shows exemplary pressure curves shown in FIG. 5 but with a zero Kpa line showing oscillation between positive and negative pressure. Such oscillation can be used to modulate fluid from a bead or droplet state exuded from pores in porous media 103 on emissive surface 102 to a retracted fluid state where beaded or droplet fluids have been sucked or withdrawn back into the pores.

Exemplary pressure modulation of fluid emitted into the exemplary emittance space can be designed and controlled to achieve optimized surface areas by the pressure. Exemplary optimized pressure(s) can be designed based upon expansion method, fluid material, maximum pressure, and/or porous media 103 of the emittance space.

Methods of operation can include providing an exemplary embodiment of the invention, determining a pattern of modulation to generate emissions or absorption patterns from a fluid, then modulating pressure flow(s) of one or more fluid paths into a fluid emission structure based on the pattern of modulation by selectively controlling fluid pumping system(s) to generate fluid flows from the fluid emission structure.

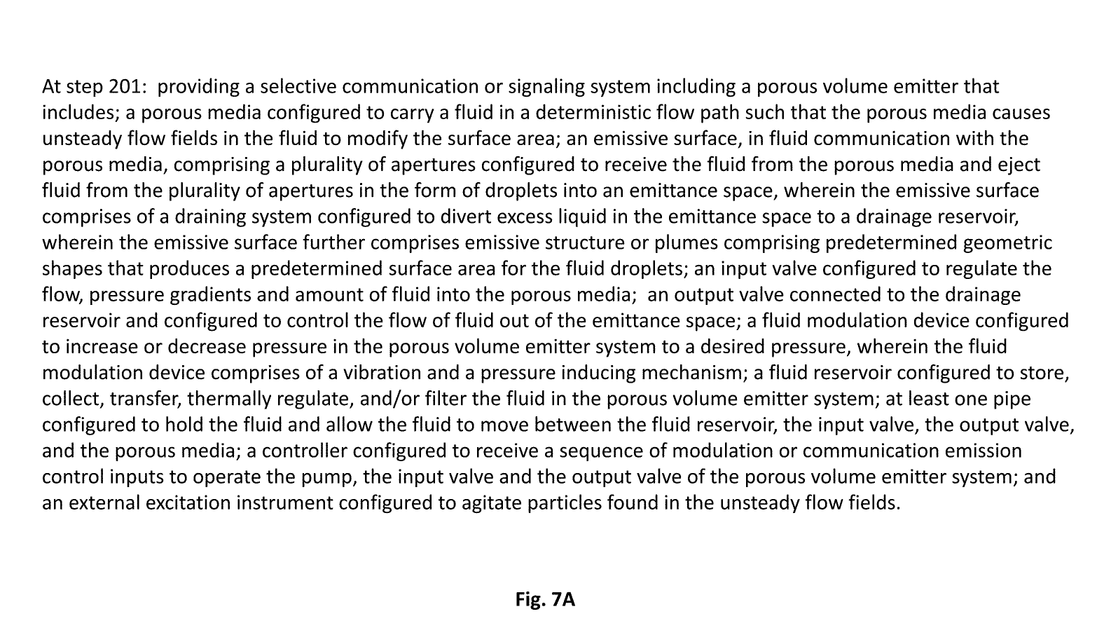

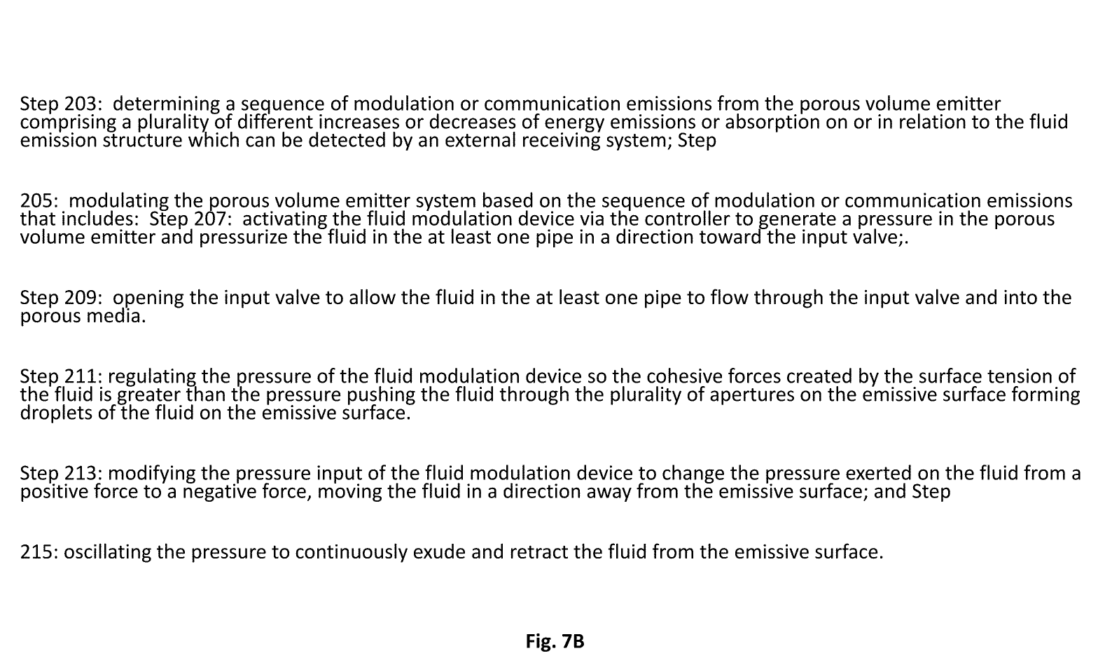

In particular, referring to FIGS. 7A and 7B, an exemplary method is shown for using a selective communication or signaling system. At step 301: providing a selective communication or signaling system including a porous volume emitter that includes; a porous media configured to carry a fluid in a deterministic flow path such that the porous media causes unsteady flow fields in the fluid to modify the surface area; an emissive surface, in fluid communication with the porous media, comprising a plurality of apertures configured to receive the fluid from the porous media and eject fluid from the plurality of apertures in the form of droplets into an emittance space, wherein the emissive surface comprises of a draining system configured to divert excess liquid in the emittance space to a drainage reservoir, wherein the emissive surface further comprises emissive structure or plumes comprising predetermined geometric shapes that produces a predetermined surface area for the fluid droplets; an input valve configured to regulate the flow, pressure gradients and amount of fluid into the porous media; an output valve connected to the drainage reservoir and configured to control the flow of fluid out of the emittance space; a fluid modulation device configured to increase or decrease pressure in the porous volume emitter system to a desired pressure, wherein the fluid modulation device comprises of a vibration and a pressure inducing mechanism; a fluid reservoir configured to store, collect, transfer, thermally regulate, and/or filter the fluid in the porous volume emitter system; at least one pipe configured to hold the fluid and allow the fluid to move between the fluid reservoir, the input valve, the output valve, and the porous media; a controller configured to receive a sequence of modulation or communication emission control inputs to operate the pump, the input valve and the output valve of the porous volume emitter system; and an external excitation instrument configured to agitate particles found in the unsteady flow fields. Step 303: determining a sequence of modulation or communication emissions from the porous volume emitter comprising a plurality of different increases or decreases of energy emissions or absorption on or in relation to the fluid emission structure which can be detected by an external receiving system; Step 305: modulating the porous volume emitter system based on the sequence of modulation or communication emissions that includes: Step 307: activating the fluid modulation device via the controller to generate a pressure in the porous volume emitter and pressurize the fluid in the at least one pipe in a direction toward the input valve. Step 309: opening the input valve to allow the fluid in the at least one pipe to flow through the input valve and into the porous media. Step 311: regulating the pressure of the fluid modulation device so the cohesive forces created by the surface tension of the fluid is greater than the pressure pushing the fluid through the plurality of apertures on the emissive surface forming droplets of the fluid on the emissive surface. Step 313: modifying the pressure input of the fluid modulation device to change the pressure exerted on the fluid from a positive force to a negative force, moving the fluid in a direction away from the emissive surface; and Step 315: oscillating the pressure to continuously exude and retract the fluid from the emissive surface. This exemplary method can further include providing a fluid collection system coupled with either the second surface or a gap operating the fluid collection system selectively remove said fluid from the porous media or the gap or emittance space to a drainage reservoir or returning said fluid to the fluid reservoir. The exemplary method can further include providing a pressurized tank connected to the second side of the porous media, where the system is configured to cause the fluid to be evenly pressurized to a predetermined pressure. The exemplary method can further include an apparatus where the pressurized tank, control system, and porous media control fluid transfer to cause said fluid to be evenly pressurized to said predetermined pressure before entering the plurality of apertures or pores of the porous media.

Although the invention has been described in detail with reference to certain preferred embodiments, variations and modifications exist within the spirit and scope of the invention as described and defined in the following claims.

1. A selective communication or signaling system comprising:
a porous media comprising a first and an opposing second side, the first side is formed with an emissive surface having a first surface area, the porous media formed with internal structures that carry fluid in deterministic flow paths such that the porous media causes unsteady flow fields in a fluid resulting in said fluid passing to said first surface area of the emissive surface, wherein the emissive surface is formed with a plurality of apertures configured to selectively exude fluid from the porous media as semi-spherical shapes, droplet or beads form to create a second surface area that is greater than said first surface area;
a fluid reservoir including a thermal control system configured to store, collect, transfer, thermally regulate, and/or filter the fluid;
a fluid pump coupled to fluid reservoir and the fluid reservoir that selectively pumps said fluid from the reservoir;
an input valve in fluid communication with the fluid reservoir and the second side of the porous media, wherein the input value is configured to selectively receive said fluid from the fluid pump and regulate at least flow, pressure gradients and amount of the fluid into the porous media;
an output valve disposed in fluid communication between a second section of the second side and the fluid reservoir, the output valve configured to selectively control fluid flow out of the second side of the porous media;
a controller configured to control operation of the thermal control system and pump, the input valve, and the output valve based on an input modulation sequence that pulses, controls, or selectively exudes said fluid from the porous media as semi-spherical shapes, droplet or beads form to create said second surface area that is greater than said first surface area;
an enclosure or housing coupled with an outer perimeter of the first side of the porous media, extending away from the first side of the porous media, and surrounding the emissive surface; and
a lens structure formed with a material which passes or is transparent to thermal energy, the lens structure is coupled with the enclosure or housing and is disposed above the first side of the porous media and coupled with the outer perimeter of the first side such that a gap is provided between the lens structure and the first side of the porous media.

2. The selective communication or signaling system as in claim 1, wherein the controller further includes control logic that selectively operates the fluid pump, the input valve and the output valve to selectively exude or withdraw the fluid from the plurality of apertures based on a predetermined modulation pattern.

3. The selective communication or signaling system as in claim 2, wherein the control logic selectively operates the fluid pump so that the fluid extends no further than a distance from said emissive surface such that said fluid does not flow laterally away from at least some of said apertures.

4. The selective communication or signaling system as in claim 1, wherein the plurality of apertures each comprise a pore structure in fluid communication with at least one said internal structures.

5. A selective communication or signaling system as in claim 1, further comprising a user interface that controls said controller and receives modulation inputs to control said pump.

6. A selective communication or signaling system including a porous volume emitter system comprising:
an enclosure with a transparent side;
a porous media disposed within or coupled with the enclosure, wherein the porous media is formed having a first side and second side opposite the first side, the porous media formed with internal porous structures that pass fluid through the porous media to the first side, the first side comprising an emissive surface having a first surface area, the emissive surface formed with a plurality of apertures or pores each in fluid communication with respective said internal structures that form fluid flow paths through the porous media from the first side to the second side, wherein said emissive surface is disposed facing the transparent side of the enclosure and is spaced apparent from the transparent side providing a gap between the transparent side and the emissive surface;
an input valve in fluid communication with the second side configured to regulate flow, pressure gradients and amount of the fluid into the porous media from the second side;
an output valve connected to a reservoir and configured to control flow of fluid out of the porous media's second side;
a fluid movement device that selectively passes the fluid to the porous media to increase or decrease pressure in the porous volume emitter system to a predetermined pressure;
a fluid reservoir configured to store, collect, transfer, thermally regulate, and/or filter the fluid in the porous volume emitter system; and
a controller configured to manipulate the pump, the input valve and the output valve of the porous volume emitter system.

7. The selective communication or signaling system as in claim 6, further comprising a fluid collection system coupled either the second side or the enclosure in fluid communication with the gap area between the transparent surface and the emissive surface, wherein the fluid collection system is configured to remove said fluid from the porous media or the gap or emittance space to a drainage reservoir or returning said fluid to the fluid reservoir.

8. The selective communication or signaling system as in claim 6, further comprising a pressurized tank connected to the second side of the porous media, said system is configured to cause the fluid to be evenly pressurized to a predetermined pressure

9. The selective communication or signaling system as in claim 8, wherein the pressurized tank, control system, and porous media control fluid transfer to cause said fluid to be evenly pressurized to said predetermined pressure before entering the plurality of apertures or pores of the porous media.

10. A method of using a selective communication or signaling system comprising:
providing a selective communication or signaling system including a porous volume emitter comprising;
a porous media configured to carry a fluid in a deterministic flow path such that the porous media causes unsteady flow fields in the fluid to modify the surface area;
an emissive surface, in fluid communication with the porous media, comprising a plurality of apertures configured to receive the fluid from the porous media and eject fluid from the plurality of apertures in the form of droplets into an emittance space, wherein the emissive surface comprises of a draining system configured to divert excess liquid in the emittance space to a drainage reservoir, wherein the emissive surface further comprises emissive structure or plumes comprising predetermined geometric shapes that produces a predetermined surface area for the fluid droplets;
an input valve configured to regulate the flow, pressure gradients and amount of fluid into the porous media;
an output valve connected to the drainage reservoir and configured to control the flow of fluid out of the emittance space;
a fluid modulation device configured to increase or decrease pressure in the porous volume emitter system to a desired pressure, wherein the fluid modulation device comprises of a vibration and a pressure inducing mechanism;
a fluid reservoir configured to store, collect, transfer, thermally regulate, and/or filter the fluid in the porous volume emitter system;
at least one pipe configured to hold the fluid and allow the fluid to move between the fluid reservoir, the input valve, the output valve, and the porous media;
a controller configured to receive a sequence of modulation or communication emission control inputs to operate the pump, the input valve and the output valve of the porous volume emitter system; and
an external excitation instrument configured to agitate particles found in the unsteady flow fields;
determining a sequence of modulation or communication emissions from the porous volume emitter comprising a plurality of different increases or decreases of energy emissions or absorption on or in relation to the fluid emission structure which can be detected by an external receiving system;
modulating the porous volume emitter system based on the sequence of modulation or communication emissions comprising:
activating the fluid modulation device via the controller to generate a pressure in the porous volume emitter and pressurize the fluid in the at least one pipe in a direction toward the input valve;
opening the input valve to allow the fluid in the at least one pipe to flow through the input valve and into the porous media;
regulating the pressure of the fluid modulation device so the cohesive forces created by the surface tension of the fluid is greater than the pressure pushing the fluid through the plurality of apertures on the emissive surface forming droplets of the fluid on the emissive surface;
modifying the pressure input of the fluid modulation device to change the pressure exerted on the fluid from a positive force to a negative force, moving the fluid in a direction away from the emissive surface; and
oscillating the pressure to continuously exude and retract the fluid from the emissive surface.

11. The method as in claim 10, further comprising a fluid collection system coupled with either the second surface or a gap operating the fluid collection system selectively remove said fluid from the porous media or the gap or emittance space to a drainage reservoir or returning said fluid to the fluid reservoir.

12. The method as in claim 10, further comprising a pressurized tank connected to the second side of the porous media, said system is configured to cause the fluid to be evenly pressurized to a predetermined pressure.

13. The method as in claim 12, wherein the pressurized tank, control system, and porous media control fluid transfer to cause said fluid to be evenly pressurized to said predetermined pressure before entering the plurality of apertures or pores of the porous media.
